(19) United States
(12) Patent Application Publication
(10) Pub. No.: US 2008/0286609 A1
(43) Pub. Date: Nov. 20, 2008

(54) LOW EMBODIED ENERGY WALLBOARDS AND METHODS OF MAKING SAME

(76) Inventors: Kevin J. Surace, Sunnyvale, CA (US); Meredith Ware, East Palo Alto, CA (US); Ramkumar Natarajan, Tamil Nadu (IN); Caroline L. Poche, Sunnyvale, CA (US); James F. Seufert, North Tonawanda, NY (US)

Correspondence Address: MACPHERSON KWOK CHEN & HEID LLP, 2033 GATEWAY PLACE, SUITE 400, SAN JOSE, CA, 95110, US

(21) Appl. No.: 11/749,031

(22) Filed: May 15, 2007

(51) Int. Cl. E04C 2/04; B29C 39/00; B32B 9/00

(52) U.S. Cl. 428/702; 264/241

(57) ABSTRACT

Wallboards, as well as cement boards, are produced by methods which use significantly reduced Embodied Energy when compared with the energy used to fabricate gypsum wallboard. A novel binder, consisting in one embodiment of phosphoric acid and calcium silicate, and combined with various fillers, is used to provide a controlled exothermic reaction to create a gypsum-board-like core which can be wrapped in a selected material such as recycled paper and manufactured on a conveyor system to appear and handle like gypsum wallboard, but without the large amounts of energy required to make gypsum wallboard. The resulting product may be used in interior or exterior applications and may possess fire resistance, sound ratings and other important properties of gypsum wallboard. As energy costs increase, the novel wallboards of this invention can become less expensive to manufacture than traditional wallboard. The manufacturing process results in much lower greenhouse gas emissions than the processes used to make gypsum wallboard.

### FIELD OF INVENTION

The present invention relates to new compositions of wallboard cores and the processes for fabricating such cores and in particular to cores and processes which reduce the energy required to manufacture the wallboards when compared to the energy required to manufacture traditional gypsum wallboard.

### BACKGROUND OF THE INVENTION

Gypsum wallboard is used in the construction of residential and commercial buildings to form interior walls and ceilings and also exterior walls in certain situations. Because it is relatively easy to install and requires minimal finishing, gypsum wallboard is the preferred material to be used for this purpose in constructing homes and offices.

Gypsum wallboard consists of a hardened gypsum-containing core surfaced with paper or other fibrous material suitable for receiving a coating such as paint. It is common to manufacture gypsum wallboard by placing an aqueous core slurry comprised predominantly of calcined gypsum between two sheets of paper thereby forming a sandwich structure. Various types of cover paper are known in the art. The aqueous gypsum core slurry is allowed to set or harden by rehydration of the calcined gypsum, usually followed by heat treatment in a dryer to remove excess water. After the gypsum slurry has set (i.e., reacted with water present in the aqueous slurry) and dried, the formed sheet is cut into required sizes. Methods for the production of gypsum wallboard are well known in the art.

A conventional process for manufacturing the core composition of gypsum wallboard initially includes the premixing of dry ingredients in a high-speed mixing apparatus. The dry ingredients often include calcium sulfate hemihydrate (stucco), an accelerator, and an antidesiccant (e.g., starch). The dry ingredients are mixed together with a “wet” (aqueous) portion of the core composition in a mixer apparatus. The wet portion can include a first component that includes a mixture of water, paper pulp, and, optionally, one or more fluidity-increasing agents, and a set retarder. The paper pulp solution provides a major portion of the water that forms the gypsum slurry of the core composition. A second wet component can include a mixture of the aforementioned strengthening agent, foam, and other conventional additives, if desired. Together, the aforementioned dry and wet portions comprise an aqueous gypsum slurry that eventually forms a gypsum wallboard core.

A major ingredient of the gypsum wallboard core is calcium sulfate hemihydrate, commonly referred to as “calcined gypsum,” “stucco,” or “plaster of Paris.” Stucco has a number of desirable physical properties including, but not limited to, fire resistance, thermal and hydrometric dimensional stability, compressive strength, and neutral pH. Typically, stucco is prepared by drying, grinding, and calcining natural gypsum rock (i.e., calcium sulfate dihydrate). The drying step in the manufacture of stucco includes passing crude gypsum rock through a rotary kiln to remove any moisture present in the rock from rain or snow, for example. The dried rock then is ground to a desired fineness. The dried, fine-ground gypsum can be referred to as “land plaster” regardless of its intended use. The land plaster is used as feed to calcination processes for conversion to stucco.

The calcination (or dehydration) step in the manufacture of stucco is performed by heating the land plaster which yields calcium sulfate hemihydrate (stucco) and water vapor.

This calcination process step is performed in a “calciner”, of which there are several types known by those of skill in the art.

Calcined gypsum reacts directly with water and can “set” when mixed with water in the proper ratios. However, the calcining process itself is energy intensive. Several methods have been described for calcining gypsum using single and multi staged apparatus, such as that described in U.S. Pat. No. 5,954,497.

Conventionally in the manufacture of gypsum board, the gypsum slurry, which may consist of several additives to reduce weight and add other properties, is deposited upon a moving paper (or fiberglass matt) substrate, which, itself, is supported on a long moving belt. A second paper substrate is then applied on top of the slurry to constitute the second face of the gypsum board and the sandwich is passed through a forming station, which determines the width and thickness of the gypsum board. In such a continuous operation the gypsum slurry begins to set after passing through the forming station. When sufficient setting has occurred the board is cut into commercially acceptable lengths and then passed into a board dryer. Thereafter the board is trimmed if desired, taped, bundled, shipped, and stored prior to sale.

The majority of gypsum wallboard is sold in sheets that are four feet wide and eight feet long. The thicknesses of the sheets vary from one-quarter inch to one inch depending upon the particular grade and application, with a thickness of ½″ or ⅝″ being common. A variety of sheet sizes and thicknesses of gypsum wallboard are produced for various applications. Such boards are easy to use and can be easily scored and snapped to break them in relatively clean lines.

The process to manufacture gypsum wallboard is by some accounts over 100 years old. It was developed at a time when energy was plentiful and cheap, and greenhouse gas issues were unknown. This is an important attribute. While gypsum wallboard technology has improved over the years to include fire resistance as an attribute of certain wallboards, and gypsum wallboard testing has been standardized (such as in ASTM C1396), there has been little change in the major manufacturing steps, and the majority of wallboard is still made from calcined gypsum.

As shown in FIG. 1, which depicts the major steps in a typical process to manufacture gypsum wallboard, gypsum wallboard requires significant energy to produce. “Embodied Energy” is defined as “the total energy required to produce a product from the raw materials stage through delivery” of finished product. As shown in FIG. 1, four of the steps (drying gypsum, calcining gypsum, mixing the slurry with hot water and drying the boards) in the manufacture of gypsum wallboard take considerable energy. Thus the Embodied Energy of gypsum, and the resultant greenhouse gasses, are very high. However few other building materials exist today to replace gypsum wallboard.

Energy is used throughout the gypsum process. After the gypsum rock is pulled from the ground it must be dried, typically in a rotary or flash dryer. Then it must be crushed and then calcined (though crushing often comes before drying). All of these processes require significant energy just to prepare the gypsum for use in the manufacturing process. After it has been calcined, it is then mixed typically with water to form a slurry which begins to set, after which the boards (cut from the set slurry) are dried in large board driers for about 40 to 60 minutes to evaporate the residual water, using significant energy. Often up to one pound (1 lb) per square foot of water needs to be dried back out of the gypsum board prior to packing. Thus, it would be highly desirable to reduce the total Embodied Energy of gypsum wallboard, thus reducing energy costs and greenhouse gasses.

Greenhouse gasses, particularly CO₂, are produced from the burning of fossil fuels and also as a result of calcining certain materials, such as gypsum. Thus the gypsum manufacturing process generates significant amounts of greenhouse gasses due to the requirements of the process.

According to the National Institute of Standards and Technology (NIST—US Department of Commerce), specifically NISTIR 6916, the manufacture of gypsum wallboard requires 8,196 BTU's per pound. With an average ⅝″ gypsum board weighing approximately 75 pounds, this equates to over 600,000 BTU's per board total Embodied Energy. Other sources suggest that Embodied Energy is much less than 600,000 BTU's per board, and may be closer to 100,000 BTU per ⅝″ board in a modern plant. Still, this is quite significant. It has been estimated that Embodied Energy constitutes over 30% of the cost of manufacture. As energy costs increase, and if carbon taxes are enacted, the cost of manufacturing wallboard from calcined gypsum will continue to go up directly with the cost of energy. Moreover, material producers carry the responsibility to find less-energy dependent alternatives for widely used products as part of a global initiative to combat climate change.

The use of energy in the manufacture of gypsum wallboard has been estimated to be 1% or more of all industrial energy usage (in BTU's) in the US. With 40 to 50 billion square feet of wallboard used each year in the US, some 300 trillion BTU's may be consumed in the manufacture of same. And as such, more than 25 million tons of greenhouse gasses are released into the atmosphere through the burning of fossil fuels to support the heat intensive processes, thus harming the environment and contributing to global warming.

Prior art focuses on reducing the weight of gypsum board or increasing its strength, or making minor reductions in energy use. For example in U.S. Pat. No. 6,699,426, a method is described which uses additives in gypsum board to reduce the drying time and thus reduce energy usage at the drying stage. These attempts generally assume the use of calcined gypsum (either natural or synthetic), since gypsum wallboard manufacturers would find that redesigning the materials and mining procedures from scratch would potentially throw away billions of dollars of infrastructure and know-how, and render their gypsum mines worthless.

However, given concerns about climate change, it would be desirable to manufacture wallboard which requires dramatically less energy usage during manufacture including elimination of calcining, hot water, and drying steps common to gypsum wallboard manufacturing.

### SUMMARY OF INVENTION

In accordance with the present invention, new methods of manufacturing novel wallboards (defined herein as “EcoRock™” wallboards), are provided. The resulting novel EcoRock wallboards can replace gypsum wallboard or water-resistant cement boards in most applications. Wallboards formulated in such a way significantly reduce the Embodied Energy associated with the wallboards, thus substantially reducing greenhouse gas emissions that harm the environment.

This invention will be fully understood in light of the following detailed description taken together with the drawings.

### DRAWINGS

FIG. 1 shows certain standard gypsum drywall manufacturing steps, specifically those which consume substantial amounts of energy.

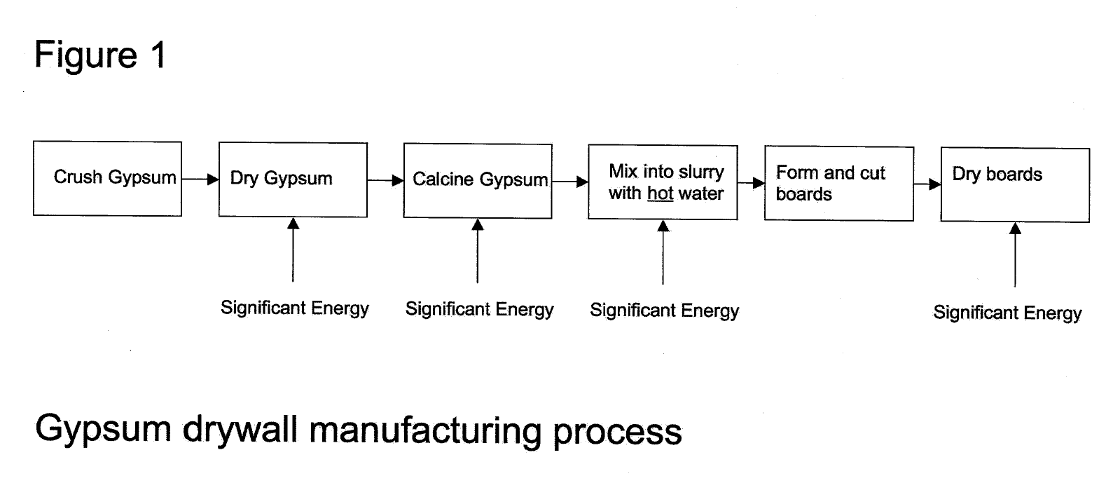

FIG. 2 shows the EcoRock manufacturing steps which as shown require little energy.

### DETAILED DESCRIPTION

The following detailed description of embodiments of the invention is illustrative only and not limiting. Other embodiments will be obvious to those skilled in the art in view of this description. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. Various changes in the details may be made without departing from the spirit, or sacrificing any of the advantages of the present invention. The detailed descriptions below are designed to make such embodiments obvious to a person of ordinary skill in the art.

The novel processes as described herein for manufacturing wallboard eliminate the most energy intensive prior art processes in the manufacture of gypsum wallboard such as gypsum drying, calcining, and board drying. The new processes allow wallboard to be formed from non-calcined materials which are plentiful and safe and which can react naturally to form a strong board that is also fire resistant. Wallboard may be produced to meet both interior and exterior requirements. Other shapes may also be produced for use in constructing buildings or infrastructure using these same methods.

This new EcoRock wallboard contains a binder of a metal silicate (calcium silicate, magnesium silicate, zirconium silicate) or calcium aluminate and a solution of acid phosphate (phosphoric acid, sodium dihydrogen phosphate, monopotassium phosphate, potassium dihydrogen phosphate, tripotassium phosphate, triple super phosphate, calcium dihydrogen phosphate, or dipotassium phosphate). The powdered binder materials, often together with fillers, are mixed together at the start of the particular EcoRock manufacturing process or processes selected to be used to form the EcoRock wallboard or wallboards. Prior to the addition of liquids, such as water and phosphoric acid, this mix of binder component(s) and filler powders is called the “dry mix.”

U.S. Pat. No. 4,956,321 discusses the treatment of wollastonite (calcium silicate) with a low percentage solution of either sulfuric acid, acetic acid or carbonic acid to create a surface pacified wollastonite. The purpose of this is to make the wollastonite inert when the treated wollastinate is used in applications requiring an inert filler or thickener, and in no way is mentioned as a binding agent or in wallboard applications. Similarly, U.S. Pat. No. 3,642,511 which uses an acid and wollastonite mixture to achieve low density, passive, brighter pigments yet again is not intended as a binder or in wallboard applications.

U.S. Pat. No. 4,375,516 creates a formulation for making water resistant phosphate ceramics by use of a silicate, phosphoric acid and powder metal. While these are similar binder ingredients to those used in the EcoRock wallboard, a wallboard for use in building construction is not described nor contemplated. Nor does this patent describe any embodiment with properties that would be characteristic of wallboards (such as score and snap ability). The same is true for World Patent WO 97-19033 (controlling set times in resin compounds) and World Patent WO 00-024690 (improved patent of the aforementioned.) NOTE: The above-mentioned patent mixes cannot be applied over existing wallboards, and thus this example is simply showing prior art and the vast differences of EcoRock wallboard.

Lastly, in U.S. Pat. Nos. 6,342,284; 6,632,550; 6,815,049; 6,800,161; 6,822,033; United States Gypsum Company discusses wallboard mixes containing phosphoric acid. However, a metal silicate is not required and all claims require the addition of calcium sulfate (gypsum or synthetic gypsum,). Thus the energy consuming processing required of gypsum and synthetic gypsum are present in the production. The removal of gypsum and synthetic gypsum from wallboard slurries (and thus the removal of the embodied energy contained thereof) is a significant advantage of EcoRock wallboards. This advantage is not present in the gypsum-containing structures described in these patents.

Phosphoric acid is commonly used as a rust remover or plant nutrient at low percentage solutions. Calcium silicate, most commonly used as an antacid or anti-caking agent, is derived from naturally occurring limestone and diatomaceous rock (sedimentary rock). Calcium silicate could likely be used in a calcined or non-calcined state, however this has not been tested, since the purpose of this new wallboard is to reduce energy and thus use the non-calcined material. These ingredients may be combined in many different ratios to each other, resulting in various set times and strengths.

A process in accordance with this invention based on phosphoric acid (H₃PO₄) will now be described. Calcium silicate (CaSiO₃) and phosphoric acid (H₃PO₄) form a reaction product, namely calcium hydrogen phosphate hydrate (CaHPO₄.H₂O) and silica (SiO₂) that is formed by dissolution of CaSiO₃ in the solution of H₃PO₄ and its eventual reaction to form a solidified product. This reaction product is referred to as “binder” hereinafter. Note that a binder does not include water.

While cement boards have been described in the prior art using both Portland cement and using, in part, calcined magnesia (such as in U.S. Pat. No. 4,003,752), these boards have several issues in comparison to standard gypsum wallboard including weight, processing and score/snap capability. These boards are not manufactured using an exothermic reaction with certain phosphates as used in this invention to create the binder.

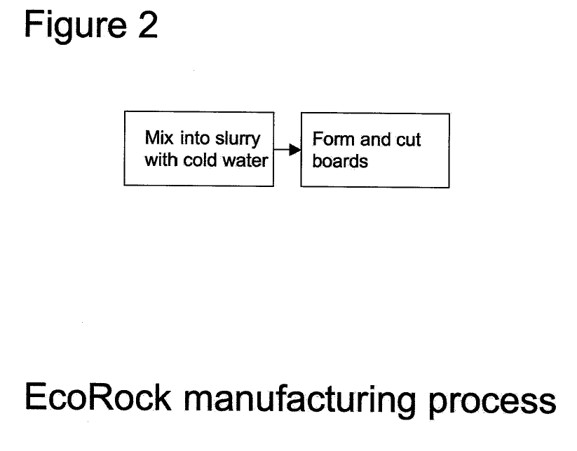

In the processes of this invention, an exothermic reaction between the binder components naturally starts and heats the slurry. The reaction time can be controlled by many factors including total composition of slurry, percent (%) binder by weight in the slurry, the fillers in the slurry, the amount of water or other liquids in the slurry and the addition of a retarder such as boric acid to the slurry. Retarders slow down the reaction. Alternate retardants can include borax, sodium tripolyphosphate, sodium sulfonate, citric acid and many other commercial retardants common to the industry. FIG. 2 shows the simplicity of the process of this invention in that FIG. 2 shows two steps: namely mixing the slurry with unheated water and then forming the wallboards from the slurry. The wallboards can either be formed in molds or formed using a conveyor system of the type used to form gypsum wallboards and then cut to the desired size.

In the process of FIG. 2, the slurry starts thickening quickly, the exothermic reaction proceeds to heat the slurry and eventually the slurry sets into a hard mass. Typically maximum temperatures of 40° C. to 90° C. have been observed depending on filler content and size of mix. The hardness can also be controlled by fillers, and can vary from extremely hard and strong to soft (but dry) and easy to break. Set time, strength required to remove the boards from molds or from a continuous slurry line, can be designed from twenty (20) seconds to days, depending on the additives or fillers. For instance boric acid can extend the set time from seconds to hours where powdered boric acid is added to the binder in a range of 0% (seconds) to 4% (hours). While a set time of twenty (20) seconds leads to extreme productivity, the slurry may begin to set too soon for high quality manufacturing, and thus the set time should be adjusted to a longer period of time typically by adding boric acid. The use of one and two tenths percent (1.2%) of boric acid gives approximately a four minute set time.

Many different configurations of materials are possible in accordance with this invention, resulting in improved strength, hardness, score/snap capability, paper adhesion, thermal resistance, weight and fire resistance. The binder is compatible with many different fillers including calcium carbonate (CaCO₃), cornstarch, wheat starch, tapioca starch, potato starch, ceramic microspheres, perlite, foam, fibers, fly ash, slag, waste products and other low-embodied energy materials. Uncalcined gypsum may also be used as a filler but is not required as part of the binder. By carefully choosing low-energy, plentiful, biodegradable materials as fillers, such as those listed above, the wallboard begins to take on the characteristics of gypsum wallboard. These characteristics (weight, structural strength so as to be able to be carried, the ability to be scored and then broken along the score line, the ability to resist fire, and the ability to be nailed or otherwise attached to other materials such as studs) are important to the marketplace and are required to make the product a commercial success as a gypsum wallboard replacement.

Calcium carbonate (CaCO₃) is plentiful and non-toxic. Cornstarch (made from corn endosperm), wheat starch (by-product of wheat gluten production), tapioca starch (extracted from tapioca plant roots), and potato starch (extracted from potato plant roots) are plentiful and non toxic. Ceramic microspheres are a waste product of coal-fired power plants, and can reduce the weight of materials as well as increase thermal and fire resistance of the wallboards that incorporate these materials. Fly ash is a waste product of coal-fired power plants which can be effectively reutilized here. Slag is a waste product produced in steel manufacturing which also can be used as filler in EcoRock wallboards. Biofibers (i.e. biodegradable plant-based fibers) are used for tensile and flexural strengthening in this embodiment; however other fibers, such as cellulose or glass, may also be used. The use of specialized fibers in cement boards is disclosed in U.S. Pat. No. 6,676,744 and is well known to those practicing the art.

### EXAMPLE 1

In one embodiment of the present invention, a dry mix of powders is prepared by mixing calcium silicate, biofibers and boric acid. Then phosphoric acid diluted by water is added to the dry mix followed by the addition of foam resulting in the following materials by approximate weight in percentages:

| | |
|---|---|
| Phosphoric acid | 17% |
| Water | 19% |
| Calcium silicate | 57% |
| Foam | 5.0% |
| Biofibers | 0.5% |
| Boric acid | 1.5% |

Phosphoric acid and calcium silicate together form a binder in the slurry and thus are present in the to-be-formed core of the EcoRock wallboard. Perlite and/or fly ash can be added to the slurry if desired in quantities up to approximately twenty percent (20%) by weight of the resulting product. Along with the foam, these materials form a filler in the slurry. The biofibers add flexural strength to the core when the slurry has hardened. Boric acid is a retardant used to slow the exothermic reaction and thus slow down the setting of the slurry.

The wet mix (the “Initial Slurry”) is mixed by the mixer in one embodiment from approximately five (5) seconds to five (5) minutes. Mixers of many varieties may be used, such as a pin mixer, provided the mix can be quickly removed from the mixer prior to hardening.

The foam is premixed separately with water (typically in a foam generator) in a concentration of 0.1% to 5% foamer agent (a soap or surfactant) by weight to the combination of foamer and water, depending on the desired elasticity. In one embodiment three-tenths of one percent (0.3%) foamer agent by weight of the resulting combination of water and roamer is used. The gypsum wallboard industry typically uses two-tenths of one percent (0.2%) roamer agent by weight. The resulting foam is added to the wet mix and as shown in paragraph [0036] above. In this example, the foam is five percent (5%) by weight of the total weight of the entire mix. The amount of foam depends on the desired density and strength of the hardened core, with 2%-15% foam by weight being optimal. Examples of foam used in gypsum wallboards include those described in U.S. Pat. No. 5,240,639, U.S. Pat. No. 5,158,612, U.S. Pat. No. 4,678,515, U.S. Pat. No. 4,618,380 and U.S. Pat. No. 4,156,615. The use of such agents is well known to those manufacturing gypsum wallboard.

The slurry may be poured onto a paper facing, which can be wrapped around the sides as in a standard gypsum process. Neither backing paper nor paper adhesives are required with this embodiment, but can be added if desired.

An exothermic reaction will begin almost immediately after removal from the mixer and continue for several hours, absorbing most of the water into the reaction. Boards can be cut and removed in less than thirty (30) minutes, depending on handling equipment available. All of the water has not yet been used in the reaction, and some absorption of the water will continue for many hours. Within twenty-four to forty-eight (24-48) hours, the majority of water has been absorbed, with some evaporation occurring as well. When paper facing is used, it is recommended that the boards be left to individually dry for 24 hours so as to reduce the possibility of mold forming on the paper. This can be accomplished on racks at room temperature with no heat required. Drying time will be faster at higher temperatures and slower at lower temperatures above freezing. Temperatures above 80° F. were tested but not considered since the design targets a low energy process. Residual drying will continue to increase at higher temperatures, however it is not beneficial to apply heat (above room temperature) due to the need of the exothermic reaction to utilize the water that would thus be evaporated too quickly. While the exothermic reaction will occur below freezing, the residual water will be frozen within the core until the temperature rises above freezing. It is presumed that ambient humidity levels will affect residual dry time as well, though this has not been investigated.

The resulting boards (the “Finished Product”) have strength characteristics similar to or greater than the strength characteristics of gypsum wallboards, and can be easily scored and snapped in the field. This binder creates the unique ability to lightly (or strongly) bond certain fillers (as compared to Portland cement, commonly used for cement boards). Cement boards (which are often used for tile backing and exterior applications) do not exhibit many of the appealing aspects of gypsum boards for internal use such as low weight, score and snap, and paper facing.

### EXAMPLE 2

In another embodiment, the same amounts of dry powders as in Example 1 are mixed together in the same proportions, but the boric acid is left out. In this case, the reaction occurs much more rapidly such that the boards may be cut and removed in under 2 minutes

### EXAMPLE 3

In another embodiment, the same proportions of materials as in Example 1 are mixed together, but the foam is substituted with flyash. This produces a board of increased strength and weight. This board utilizes recycled materials and thus may cater even more to national environmental building programs such as LEED, developed by the United States Green Building Council.

### EXAMPLE 4

In another embodiment, a board is made for exterior use (may substitute for cement board or high density gypsum board) by increasing the phosphoric acid and removing the foam in the slurry and thus in the core of the to-be-formed wallboard. This gives to the resulting EcoRock wallboard additional strength and water resistance. In addition, in this embodiment, no paper facing or wrap is used because the wallboard will be exposed to the environment. The weight of this embodiment is as follows:

| | |
|---|---|
| Phosphoric Acid | 19% |
| Water | 19% |
| Calcium Silicate | 55% |
| Perlite | 5.0% |
| Biofibers | 0.5% |
| Boric acid | 1.5% |

While the percentage binder by weight in the formulations of Examples 1 and 4 are both approximately seventy four percent (74%), the ratio of phosphoric acid to calcium silicate increases from Example 1 to Example 4. In addition it should be recognized that the percentage by weight of binder to the total weight of the resulting product can be varied from percentages as high as approximately ninety five percent (95%) down to as low as approximately fifty five percent (55%). Formulations with binders between approximately seventy percent (70%) and eighty five percent (85%), by weight of the total weight of the resulting product are preferred.

The processing of the slurry may occur using several different techniques depending on a number of factors such as quantity of boards required, manufacturing space and familiarity with the process by the current engineering staff. The normal gypsum slurry method using a conveyor system, which is a continuous long line that wraps the slurry in paper, is one acceptable method for fabricating most embodiments of the EcoRock wallboards of this invention. This process is well known to those skilled in manufacturing gypsum wallboard. Also the Hatscheck method, which is used in cement board manufacturing, is acceptable to manufacture the wallboards of this invention, specifically those that do not require paper facing or backing, and is well known to those skilled in the art of cement board manufacturing. Additional water is required to thin the slurry when the Hatscheck method is used because the manufacturing equipment used often requires a lower viscosity slurry. Alternatively as another manufacturing method, the slurry may be poured into pre-sized molds and allowed to set. Each board can then be removed from the mold, which can be reused.

Also, due to the inherent strength that can be achieved with a higher binder to filler ratio, other cementitious objects can be formed which can be used in construction or potentially other fields. These objects may not be in the form of panels but could be in the form of any cementitious objects normally made using Portland cement. Such objects can be poured and dry quickly, setting within a few minutes either in molds or on site.

Other embodiments of this invention will be obvious in view of the above disclosure.

What is claimed is:

1. A wallboard comprising a binder, said binder comprising:
one or more compounds selected from the group consisting of metal silicate and calcium aluminate; and
at least one acid phosphate.

2. The wallboard of claim 1 wherein said metal silicate comprises a mixture of one or more of calcium silicate, magnesium silicate or zirconium silicate.

3. The wallboard of claim 1 wherein said at least one acid phosphate comprises one or more compounds selected from the group consisting of phosphoric acid, sodium dihydrogen phosphate, monopotassium phosphate, potassium dihydrogen phosphate, tripotassium phosphate, triple super phosphate, calcium dihydrogen phosphate, and dipotassium phosphate.

4. The wallboard of claim 1 wherein the binder comprises approximately ninety five percent (95%) or less of the total weight of the wallboard.

5. The wallboard of claim 1 wherein the binder comprises approximately eighty five percent (85%) or less of the total weight of the wallboard.

6. The wallboard of claim 1 wherein the binder comprises approximately seventy five percent (75%) or less of the total weight of the wallboard.

7. The wallboard of claim 1 wherein the binder comprises approximately sixty five percent (65%) or less of the total weight of the wallboard.

8. The wallboard of claim 1 wherein the binder comprises approximately fifty five percent (55%) or less of the total weight of the wallboard.

9. The wallboard of claim 1, further comprising fibers selected from the group consisting of biofibers, nylon, fiberglass, cellulose and recycled petroleum waste.

10. The wallboard of claim 1 further comprising a filler of foam.

11. The wallboard of claim 1 further comprising a filler of ceramic microspheres.

12. The wallboard of claim 1 further comprising water.

13. The wallboard of claim 1 further comprising starch selected from the group consisting of cornstarch, wheat starch, tapioca starch and potato starch.

14. The wallboard of claim 1 further comprising a by-product selected from the group consisting of fly ash and slag.

15. A wallboard with an outer layer of paper on at least one (1) side, comprising:
a binder comprising:
calcium aluminate and one or more metal silicate compounds selected from the group consisting of calcium silicate, magnesium silicate, and zirconium silicate; and
one or more acid phosphate compounds selected from the group consisting of phosphoric acid, sodium dihydrogen phosphate, monopotassium phosphate, potassium dihydrogen phosphate, tripotassium phosphate, triple super phosphate, calcium dihydrogen phosphate, and dipotassium phosphate.

16. The wallboard of claim 15 wherein the binder comprises approximately ninety five percent (95%) or less of the total weight of the wallboard.

17. The wallboard of claim 15 wherein the binder comprises approximately eighty five percent (85%) or less of the total weight of the wallboard.

18. The wallboard of claim 15 wherein the binder comprises approximately seventy five percent (75%) or less of the total weight of the wallboard.

19. The wallboard of claim 15 wherein the binder comprises approximately sixty five percent (65%) or less of the total weight of the wallboard.

20. The wallboard of claim 15 wherein the binder comprises approximately fifty five percent (55%) or less of the total weight of the wallboard.

21. The wallboard of claim 15 further comprising fibers selected from the group consisting of biofibers, nylon, fiberglass, cellulose and recycled petroleum waste.

22. The wallboard of claim 15 further comprising a filler of foam.

23. The wallboard of claim 15 further comprising a filler of ceramic microspheres.

24. The wallboard of claim 15 further comprising water.

25. The wallboard of claim 15 further comprising a starch selected from the group consisting of cornstarch, wheat starch, tapioca starch and potato starch.

26. The wallboard of claim 15 further comprising a by-product selected from the group of flyash and slag.

27. A wallboard with a size of at least 16 square feet, with an average thickness between 0.1″ and 1.0″, comprising:
a binder comprising:
calcium aluminate and one or more metal silicate compounds selected from the group consisting of calcium silicate, magnesium silicate, and zirconium silicate;
one or more acid phosphate compounds selected from the group consisting of phosphoric acid, sodium dihydrogen phosphate, monopotassium phosphate, potassium dihydrogen phosphate, tripotassium phosphate, triple super phosphate, calcium dihydrogen phosphate, and dipotassium phosphate; and
an outer layer of paper on at least one (1) side of the wallboard.

28. The wallboard of claim 27 wherein the binder comprises approximately ninety five percent (95%) or less of the total weight of the product.

29. The wallboard of claim 27 where the binder comprises approximately eighty five percent (85%) or less of the total weight of the wallboard.

30. The wallboard of claim 27 wherein the binder comprises approximately seventy five percent (75%) or less of the total weight of the wallboard.

31. The wallboard of claim 27 wherein the binder comprises approximately sixty five percent (65%) or less of the total weight of the wallboard.

32. The wallboard of claim 27 wherein the binder comprises approximately fifty five percent (55%) or less of the total weight of the wallboard.

33. The wallboard of claim 27, further comprising fibers selected from the group consisting of biofibers, nylon, fiberglass, cellulose and recycled petroleum waste.

34. The wallboard of claim 27 further comprising a filler of foam.

35. The wallboard of claim 27 further comprising a filler of ceramic microspheres.

36. The wallboard of claim 27 further comprising water.

37. The wallboard of claim 27 further comprising a starch selected from the group consisting of cornstarch, wheat starch, tapioca starch and potato starch.

38. The wallboard of claim 27 further comprising a by-product selected from the group of flyash and slag.

39. A wallboard with a size of at least 16 square feet, with an average thickness between 0.1″ and 1.0″, comprising:
a binder comprising:
calcium aluminate and one or more metal silicate compounds selected from the group consisting of calcium silicate, magnesium silicate, and zirconium silicate;
one or more acid phosphate compounds selected from the group consisting of phosphoric acid, sodium dihydrogen phosphate, monopotassium phosphate, potassium dihydrogen phosphate, tripotassium phosphate, triple super phosphate, calcium dihydrogen phosphate, and dipotassium phosphate; and
an outer layer of fiberglass matt on at least one (1) side.

40. The wallboard of claim 39 wherein the binder comprises approximately ninety five percent (95%) or less of the total weight of the wallboard.

41. The wallboard of claim 39 wherein the binder comprises approximately eighty five percent (85%) or less of the total weight of the wallboard.

42. The wallboard of claim 39 wherein the binder comprises approximately seventy five percent (75%) or less of the total weight of the wallboard.

43. The wallboard of claim 39 wherein the binder comprises approximately sixty five percent (65%) or less of the total weight of the wallboard.

44. The wallboard of claim 39 wherein the binder comprises approximately fifty five percent (55%) or less of the total weight of the wallboard.

45. The wallboard of claim 39 further comprising fibers selected from the group consisting of biofibers, nylon, fiberglass, cellulose and recycled petroleum waste.

46. The wallboard of claim 39 further comprising a filler of foam.

47. The wallboard of claim 39 further comprising a filler of ceramic microspheres.

48. The wallboard of claim 39 further comprising water.

49. The wallboard of claim 39 further comprising a starch selected from the group consisting of cornstarch, wheat starch, tapioca starch and potato starch.

50. The wallboard of claim 39 further comprising a by-product selected from the group of fly ash and slag.

51. A wallboard with a size of at least 16 square feet, with an average thickness between 0.1″ and 1.0″ comprising:
a binder comprising:
calcium aluminate and one or more metal silicate compounds selected from the group consisting of calcium silicate, magnesium silicate, and zirconium silicate;
one or more acid phosphate compounds selected from the group consisting of phosphoric acid, sodium dihydrogen phosphate, monopotassium phosphate, potassium dihydrogen phosphate, tripotassium phosphate, triple super phosphate, calcium dihydrogen phosphate, and dipotassium phosphate; and
an outer layer of paper on at least one (1) side.

52. The wallboard of claim 51 wherein the binder comprises approximately ninety five percent (95%) or less of the total weight of the wallboard.

53. The wallboard of claim 51 wherein the binder comprises approximately eighty five percent (85%) or less of the total weight of the wallboard.

54. The wallboard of claim 51 wherein the binder comprises approximately seventy five percent (75%) or less of the total weight of the wallboard.

55. The wallboard of claim 51 wherein the binder comprises approximately sixty five percent (65%) or less of the total weight of the wallboard.

56. The wallboard of claim 51 wherein the binder comprises approximately fifty five percent (55%) or less of the total weight of the wallboard.

57. The wallboard of claim 51 further comprising fibers selected from the group consisting of biofibers, nylon, fiberglass, cellulose and recycled petroleum waste.

58. The wallboard of claim 51 further comprising a filler of foam.

59. The wallboard of claim 51 further comprising a filler of ceramic microspheres.

60. The wallboard of claim 51 further comprising water.

61. The wallboard of claim 51 further comprising a starch selected from the group consisting of cornstarch, wheat starch, tapioca starch and potato starch.

62. The wallboard of claim 51 further comprising a by-product selected from the group of flyash and slag.

63. A method of fabricating a wallboard, comprising:
forming an initial slurry comprising:
a mixture comprising one or more compounds selected from calcium aluminate and the group consisting of calcium silicate, magnesium silicate, and zirconium silicate;
at least one acid phosphate;
water; and
allowing the initial slurry to set.

64. The method of claim 63 further comprising cutting the set slurry to a desired shape.

65. The method of claim 63 including:
adding a material to the slurry to increase the time taken for the slurry to set.

66. The method of claim 65 wherein the material added to the slurry is boric acid.

67. The method of claim 63 wherein the at least one acid phosphate comprises one or more compounds selected from the group consisting of phosphoric acid, sodium dihydrogen phosphate, monopotassium phosphate, potassium dihydrogen phosphate, tripotassium phosphate, triple super phosphate, calcium dihydrogen phosphate, and dipotassium phosphate.

68. A method of fabricating a solid object for use in constructing buildings, comprising:
forming an initial slurry comprising:
a mixture comprising one or more compounds selected from calcium aluminate and the group consisting of calcium silicate, magnesium silicate, and zirconium silicate;
at least one acid phosphate;
water; and
allowing the initial slurry to set.

69. The method of claim 68 further comprising cutting the set slurry to a desired shape.

70. The method of claim 68 including:
adding a material to the slurry to increase the time taken for the slurry to set.

71. The method of claim 68 wherein the material added to the slurry is boric acid.

72. The method of claim 68 wherein the at least one acid phosphate comprises one or more compounds selected from the group consisting of phosphoric acid, sodium dihydrogen phosphate, monopotassium phosphate, potassium dihydrogen phosphate, tripotassium phosphate, triple super phosphate, calcium dihydrogen phosphate, and dipotassium phosphate.

73. The method of claim 68 wherein the initial slurry is poured into a mold which represents the desired shape.

74. A method of producing a cement for use in construction, comprising:
forming an initial slurry comprising:
a mixture comprising:
one or more compounds selected from calcium aluminate and the group consisting of calcium silicate, magnesium silicate, and zirconium silicate; and
at least one acid phosphate; and
allowing the slurry to set.

75. The method of claim 74 including:
adding a material to the slurry to increase the time taken for the slurry to set.

76. The method of claim 74 wherein the material added to the slurry is boric acid.

77. The method of claim 74 wherein the at least one acid phosphate comprises one or more compounds selected from the group consisting of phosphoric acid, sodium dihydrogen phosphate, monopotassium phosphate, potassium dihydrogen phosphate, tripotassium phosphate, triple super phosphate, calcium dihydrogen phosphate, and dipotassium phosphate.

78. The method of claim 74 wherein the initial slurry is poured into a mold which represents the desired shape.

79. A method of producing a cement for use in construction, comprising:
forming a mixture comprising one or more compounds selected from calcium aluminate and the metal silicate group consisting of calcium silicate, magnesium silicate, and zirconium silicate;
adding one or more acid phosphate compounds selected from the group consisting of phosphoric acid, sodium dihydrogen phosphate, monopotassium phosphate, potassium dihydrogen phosphate, tripotassium phosphate, triple super phosphate, calcium dihydrogen phosphate, and dipotassium phosphate; and
adding water.
